(19) United States
(12) Patent Application Publication
(10) Pub. No.: US 2024/0327123 A1
(43) Pub. Date: Oct. 3, 2024

(54) SYSTEMS AND METHODS FOR AUTOMATIC PRODUCT INTAKE, STOCKING, AND RETRIEVAL

(71) Applicant: COUPANG CORP., Seoul (KR)

(72) Inventors: Hyunah JOO, Seoul (KR); Dayoung KIM, Gyeonggi-do (KR); Suhyun JEONG, Gyeonggi-do (KR)

(21) Appl. No.: 18/128,422

(22) Filed: Mar. 30, 2023

(51) Int. Cl. B65G 1/137; B65G 1/04; B65G 43/08; B65G 47/90

(52) U.S. Cl. CPC B65G 1/1376; B65G 1/0414; B65G 1/0421; B65G 1/1371; B65G 43/08; B65G 47/90; B65G 2201/0267; B65G 2203/0258; B65G 2203/042

(57) ABSTRACT

Pallet transport systems and methods for product intake, stocking, and retrieval are disclosed. The systems and methods may include performing steps for: receiving a first user input corresponding to a group identification code; receiving a second user input corresponding to one or more tote identification codes to be loaded on a pallet; assigning the one or more tote identification codes to a group corresponding to the group identification code; assigning the group identification code to a location based on one or more items associated with the one or more tote identification codes; activating a conveyor to transport the pallet containing the one or more items; determining, using a first sensor input from the weight sensor, a transportability of the pallet; and causing a lift mechanism to transfer the pallet from the conveyor to a self-navigating platform.

### TECHNICAL FIELD

The present disclosure generally relates to computerized systems and methods for product intake, stocking, and retrieval. In particular, embodiments of the present disclosure relate to inventive and unconventional systems for receiving items for intake into a warehouse, sorting them into groups based on user-defined filters, and using a combination of automated transport systems for transporting them to designated locations within the warehouse.

### BACKGROUND

With the explosive growth of e-commerce and the increasing demand for faster delivery times, warehouse management has become a critical aspect of supply chain management. What has traditionally been enough to keep track with a rudimentary software and manual labor has come to require assistance of computers and robotics to achieve accuracy and efficiency.

To this end, automation can help warehouses achieve higher efficiency, accuracy, and productivity levels while reducing labor costs and minimizing the risk of errors. Automation can also provide real-time visibility into inventory levels, order status, and overall warehouse performance, enabling managers to make data-driven decisions and continuously improve operations.

Traditional automated warehouse management systems, however, continue to rely heavily on manual labor to transport items from one place to another. For example, manual labor is required to unload items from a trailer as they are delivered to the warehouse. The items are then transported to different parts of the warehouse for storage and future retrieval. While mechanical systems such as conveyors, pallet jacks, or even robot arms may be utilized during these processes, they had been disconnected from the automated warehouse management systems. For example, the use of mechanical systems has been limited to assisting an employee transport items in bulk, as opposed to reducing a number of decision points (e.g., determining where an item should go, how it should be stored, etc.) that must be made during the processes.

Therefore, there is a need for a marriage between software and mechanical systems to control flow of items within a warehouse. Such system should be able to transport items with minimal human intervention and facilitate inventory level tracking, all the while taking advantage of increased strength afforded by mechanical systems.

### SUMMARY

One aspect of the present disclosure is directed to a pallet transport system for product intake, stocking, and retrieval. The pallet transport system may comprise a memory storing instructions and at least one processor configured to execute the instructions, wherein the instructions may cause the at least one processor to perform: receiving a first user input corresponding to a group identification code; receiving a second user input corresponding to one or more tote identification codes to be loaded on a pallet; assigning the one or more tote identification codes to a group corresponding to the group identification code; assigning the group identification code to a location based on one or more items associated with the one or more tote identification codes; activating a conveyor to transport the pallet containing the one or more items; determining, using a first sensor input from the weight sensor, a transportability of the pallet; and causing a lift mechanism to transfer the pallet from the conveyor to a self-navigating platform.

Another aspect of the present disclosure is directed to a method for product intake, stocking, and retrieval. The method may comprise: receiving a first user input corresponding to a group identification code; receiving a second user input corresponding to one or more tote identification codes to be loaded on a pallet; assigning the one or more tote identification codes to a group corresponding to the group identification code; assigning the group identification code to a location based on one or more items associated with the one or more tote identification codes; activating a conveyor to transport the pallet containing the one or more items; determining, using a first sensor input from a weight sensor, a transportability of the pallet; and causing a lift mechanism to transfer the pallet from the conveyor to a self-navigating platform.

Yet another aspect of the present disclosure is directed to another pallet transport system for product intake, stocking, and retrieval. The pallet transport system may comprise: a conveyor configured to transport a pallet; a lift mechanism configured to transfer the pallet from the conveyor to a self-navigating platform; a memory storing instructions; and at least one processor configured to execute the instructions. The instructions may cause the at least one processor to perform: receiving a first user input corresponding to a group identification code; receiving a second user input corresponding to one or more tote identification codes to be loaded on the pallet; assigning the group identification code to a location based on one or more items associated with the one or more tote identification codes; activating the conveyor located on a first floor to transport the pallet containing the one or more items; and using the lift mechanism to transfer the pallet from the conveyor to a self-navigating platform located on a second floor located above or below the first floor, wherein the second floor is determined based on the assigned location.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary transport system and flow of items within another exemplary fulfillment center, consistent with the disclosed embodiments.

FIG. 4 is a flow chart of an exemplary process for managing the flow of items, consistent with the disclosed embodiments.

FIG. 5 is an exemplary graphical user interface for managing different filtering rules for facilitating the flow of items, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for automatic product intake, stocking, and retrieval.

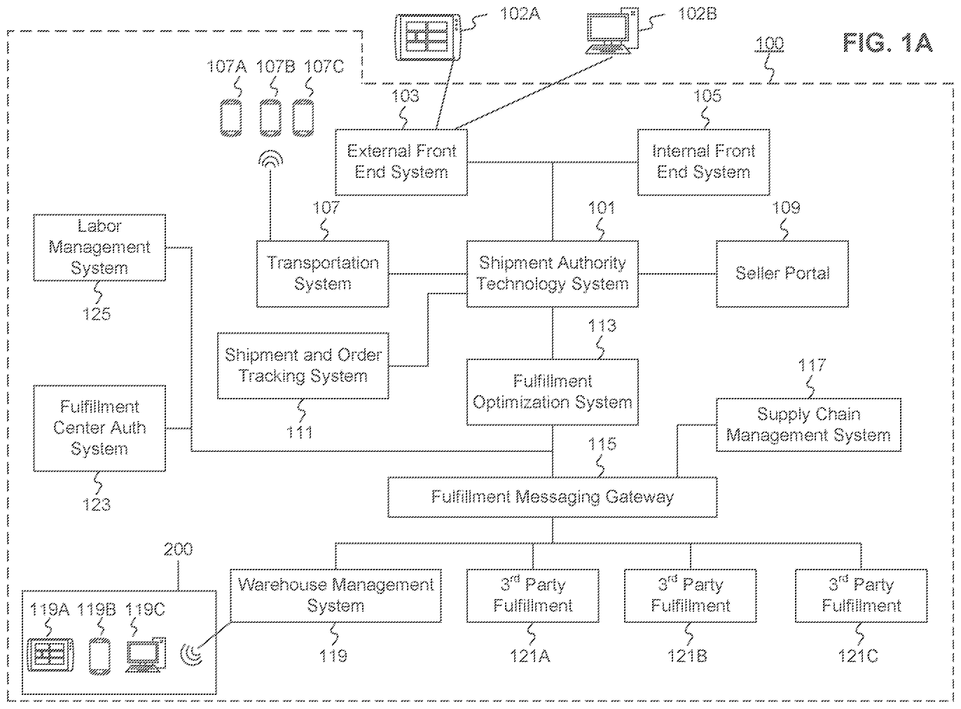

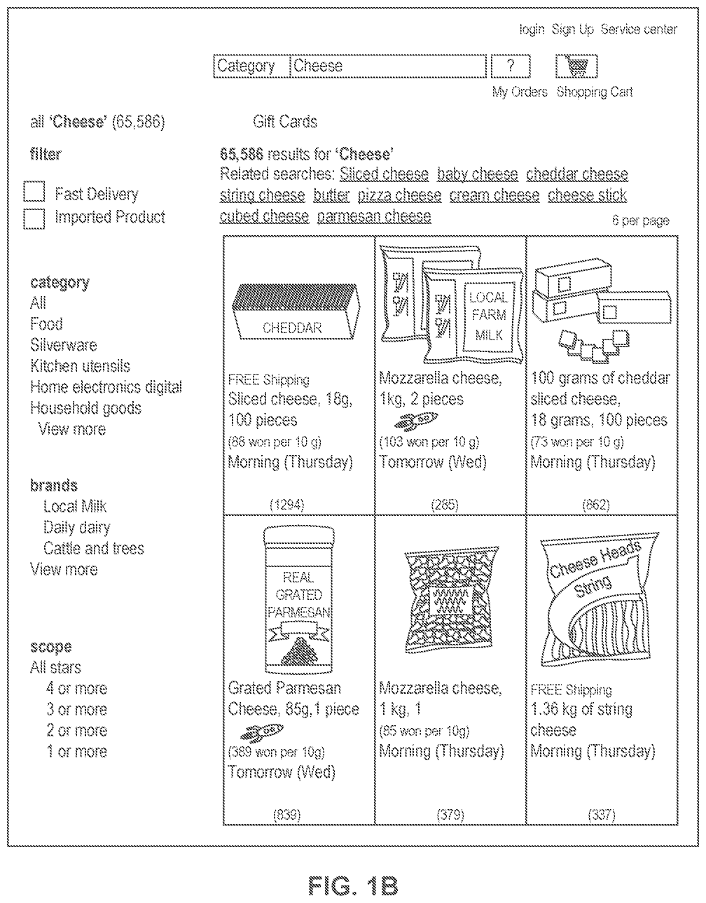

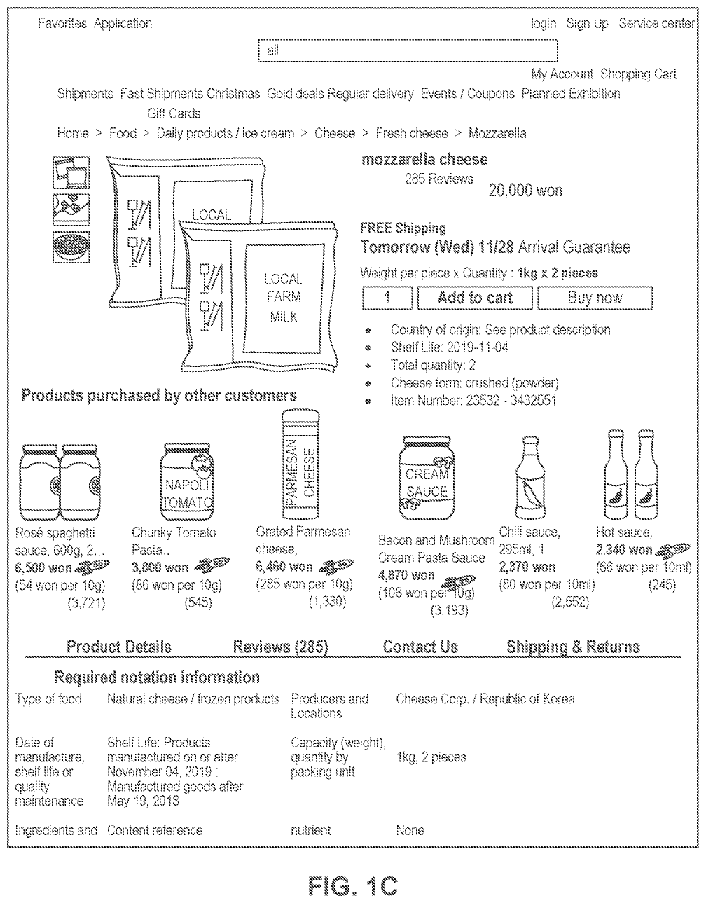

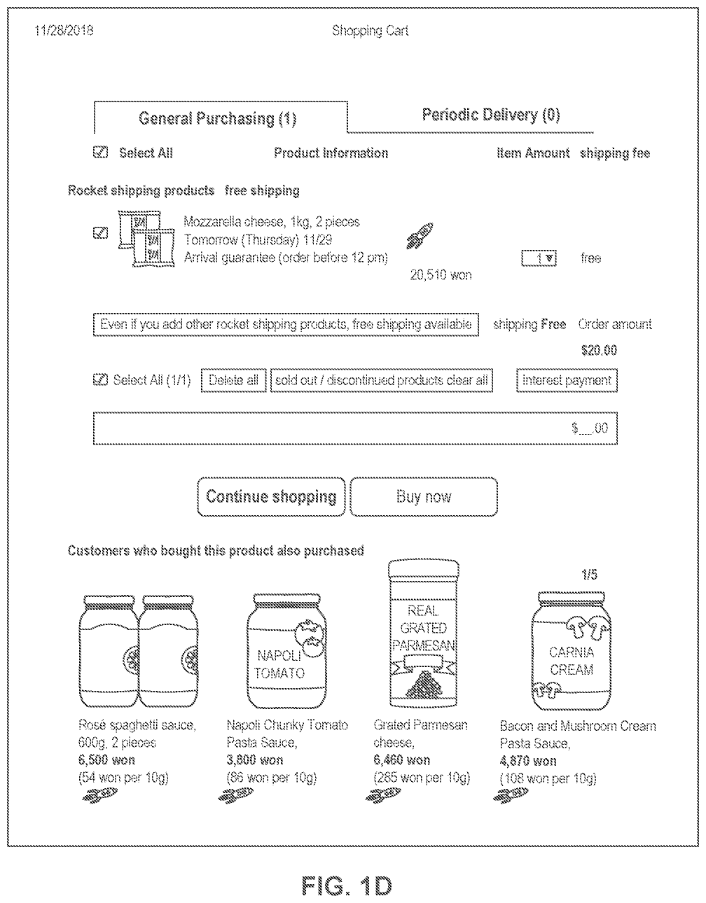

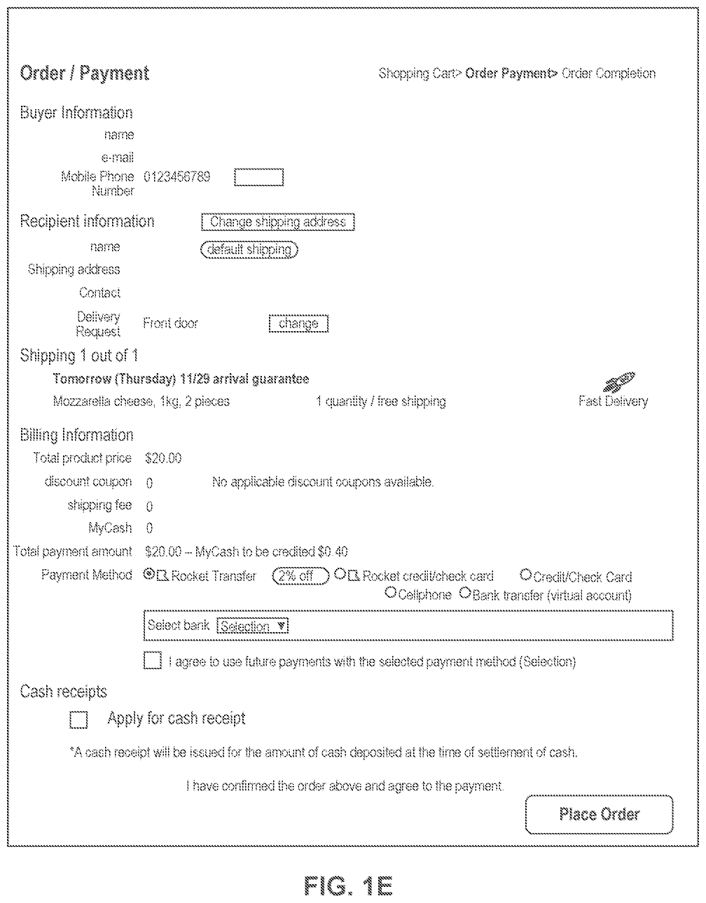

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

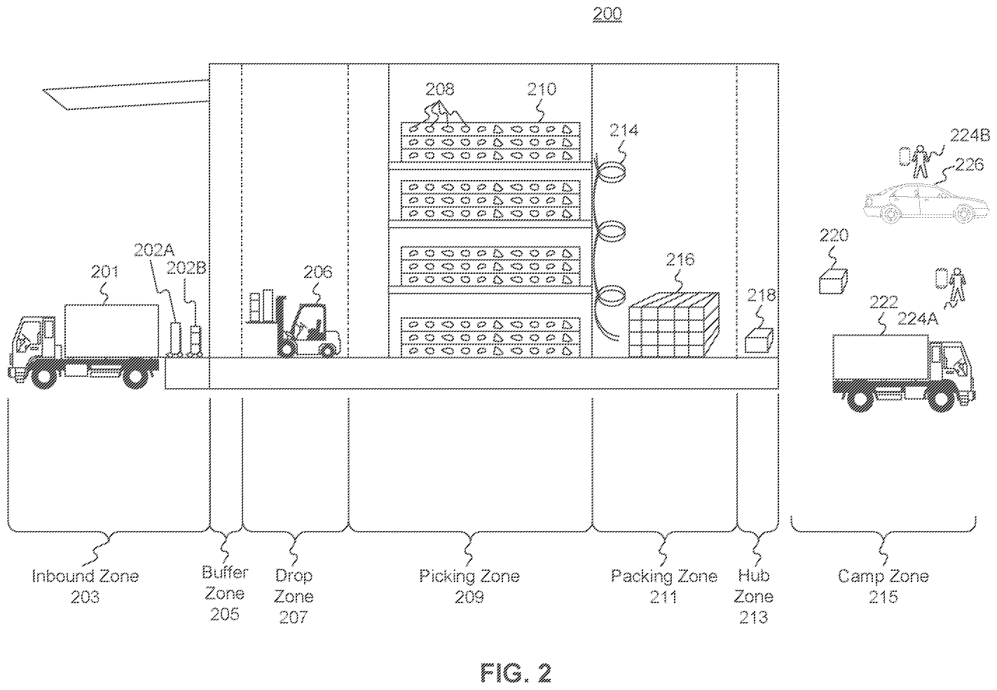

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

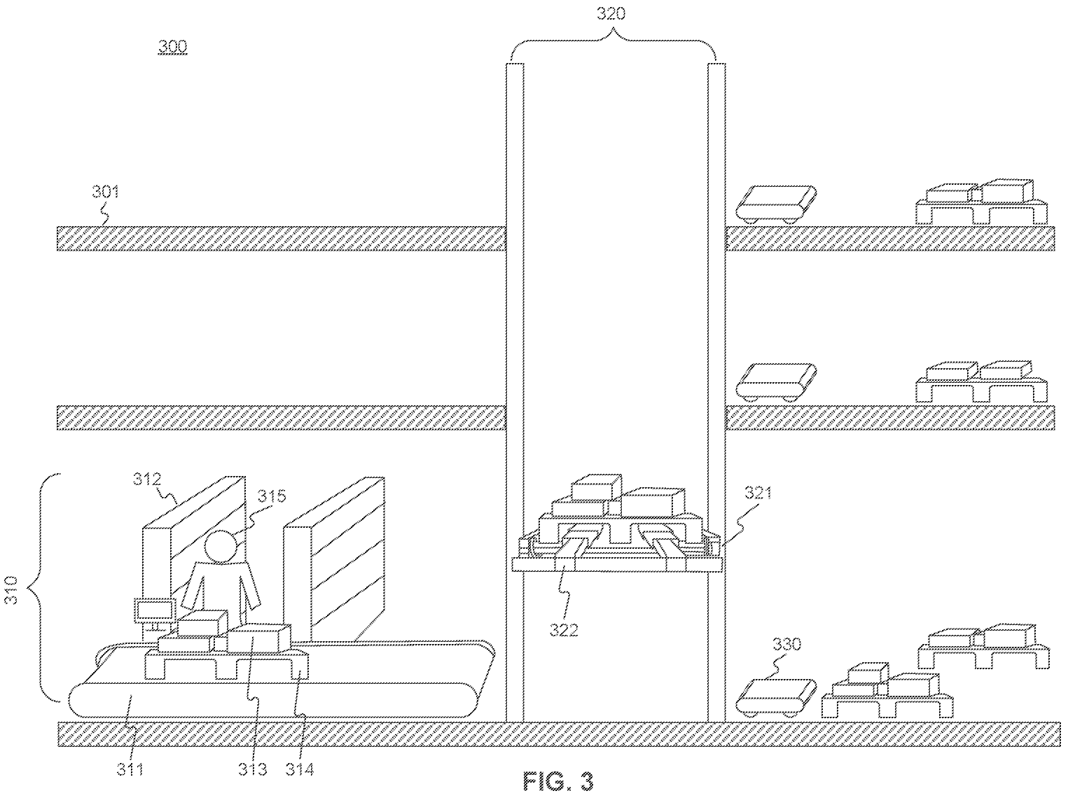

FIG. 3 is a diagrammatic illustration of an exemplary transport system and flow of items within another exemplary fulfillment center 300. In some embodiments, the fulfillment center 300 may be implemented consistent with fulfillment center 200 of FIG. 2 and comprise multiple floors above and/or below ground, as represented by separators 301. The illustrated portion of fulfillment center 300 may correspond to, for example, buffer zone 205, drop zone 207, and picking zone 209 of FIG. 2.

Main components of the transport system may comprise a conveyor network 310, a lift system 320, and self-navigating platform(s) 330. These components may be in electronic communication with various networked systems of FIG. 1A, such as WMS 119, 3^{rd} party fulfillment systems 121A-C, FMG 115, and FO system 113. While only a limited number of components are shown in FIG. 3 for illustrative purposes, none of the illustrated aspects such as the number, locations, or arrangement are intended to be limiting.

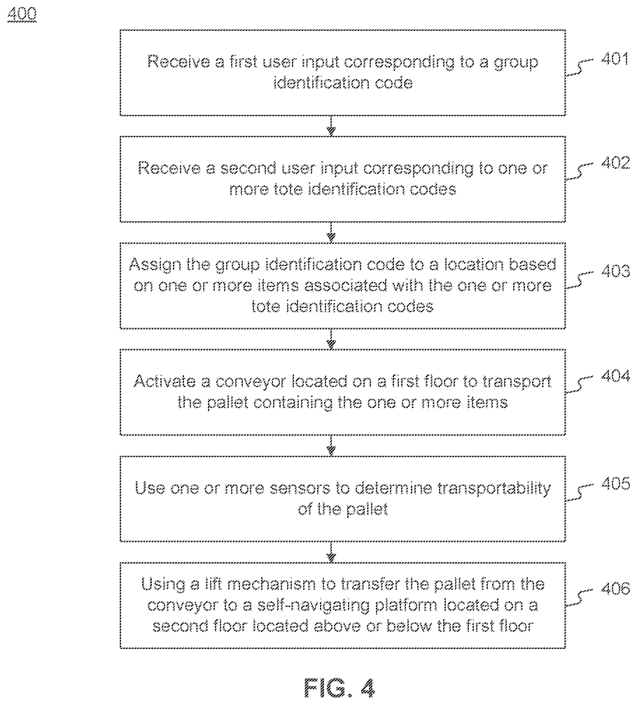

In some embodiments, conveyor network 310 may comprise a network of conveyors 311 and one or more work stations 312. Conveyors 311 may cover different areas of fulfillment center 300. For example, conveyors 311 may extend from inbound zone 203 to lift system 320 so that items 313 received at inbound zone 203 can be transported to lift system 320 without much effort by employees using disconnected instruments such as carts or forklifts. In some embodiments, work stations 312 may be located at various locations near conveyors 311. One or more workers 315 may be stationed at work stations 312, scanning items 313 as they are transported from inbound zone 203, and loading them onto a conveyor 311. In some embodiments, the items 313 may be loaded onto a pallet 314 or other shelving units. The process for loading items 313 onto conveyor 311 is described in more detail below with respect to FIG. 4.

In some embodiments, conveyors 311 may comprise a locking mechanism (not shown) configured to prevent movement of at least a section of conveyors 311. The locking mechanism may be implemented using one or both of software and hardware elements. A software lock, for example, may be configured as a software logic that denies any request from local (e.g., computer at work station 312) or networked systems (e.g., WMS 119) to activate the locked section of conveyors 311. A hardware lock, on the other hand, may comprise a locking mechanism that engages with one or more gears, chains, pulleys, or any mechanical component of conveyors 311 used to move the locked section to block any movement.

In some embodiments, lift system 320 may comprise a lift mechanism 321 or an elevator-type mechanism that is able to move up and down between different floors of fulfillment center 300. Such ability allows fulfillment center 300 to store more items 313 in a limited footprint. Lift mechanism 321 may be powered by pneumatic or hydraulic cylinders and/or a network of pulleys (not shown) to be able to lift heavy loads. In some embodiments, lift mechanism 321 may comprise extending arms 322 for transferring pallet 314 or shelving unit. For example, lift mechanism 321 may comprise a pair of extending arms configured to extend into slots on pallet 314 or shelving unit such that pallet 314 or shelving unit can be transferred onto lift mechanism 321 at once, together with all items 313 loaded on it.

In some embodiments, conveyor network 310 and/or lift system 320 may comprise one or more sensors configured to determine transportability of loaded pallet 314 or shelving unit. For example, conveyors 311, lift mechanism 321, and/or self-navigating platforms 330 may comprise a weight sensor configured to generate a signal corresponding to a gross weight of pallet 314 or shelving unit and items 313 loaded thereon. In some embodiments, there may be two or more weight sensors arranged on a section of a conveyor 311 so that weight measurements may be taken at each corner of pallet 314 or shelving unit. conveyors 311, lift mechanism 321, and self-navigating platforms 330 may be rated for transporting a certain weight maximum, beyond which the structural integrity or capabilities of conveyors 311, lift mechanism 321, or self-navigating platforms 330 may be compromised. Any pallet 314 or shelving unit loaded with items 313 to the point where the gross weight exceeds or is within a predetermine percentage of the weight maximum may be determined as not meeting the requisite transportability of pallet 314 or shelving unit.

In further embodiments, conveyors 311 and/or lift mechanism 321 may comprise a clearance sensor configured to generate a signal corresponding to length, width, and/or height of pallet 314 or shelving unit, together with items 313 loaded thereon. Conveyor network 310, lift system 320, and/or self-navigating platforms 330 may be configured to transport items of certain dimension, beyond which the items may catch on structures or other moving or non-moving objects around conveyor network 310 or lift system 320. Clearance sensor may comprise an array of one or more optical sensors, ultrasonic sensors, laser sensors, or infrared sensors, each configured to measure length, width, or height of items 313 loaded on conveyors 311 or lift mechanism 321, or the distance from the closest point on the items 313 to the respective sensor. In other embodiments, clearance sensors may generate a simple Boolean signal based on whether a sensor detected a blockage in its detection path or not. Any pallet 314 or shelving unit loaded with items 313 that extend beyond the dimensions acceptable to conveyors 311, lift mechanism 321, or self-navigating platforms 330 may be determined as not meeting the requisite transportability of pallet 314 or shelving unit. In some embodiments, various combinations of dimensions may be used to determine the transportability, such as a linear sum of overall dimensions of pallet 314 or shelving unit loaded with items 313, a minimum of the dimensions, or a maximum of the dimensions.

In some embodiments, one or more self-navigating platforms 330 may be placed in each floor of fulfillment center 300. The number of self-navigating platforms 330 in one floor may vary based on, for example, square footage of the floor, number of items, pallets 314, or shelving units to be stored on the floor, number of pallets 314 or shelving units desired to be in movement simultaneously at any given point in time, or the like. As the name suggests, self-navigating platforms 330 may be configured to navigate around various moving or non-moving objects on the floor such as other self-navigating platforms 330, any structural elements (e.g., walls, doors, or columns), people, equipment, or anything that may be found at a storage area of fulfillment center 300. In some embodiments, each self-navigating platform 330 may comprise ultrasonic sensors, light detection and ranging (lidar) sensors, optical sensors, cameras, or infrared sensors configured to detect objects or structures in its vicinity. Self-navigating platforms 330 may be configured to use output signals from these sensors to detect and navigate around other objects or structures. Additionally or alternatively, each floor of fulfillment center 300 may comprise these sensors, which may be configured to determine positions of multiple self-navigating platforms 330 and/or objects on the floor. A centralized processing system (not shown) may be configured to direct each self-navigating platform 330 (e.g., using wireless signals communicates to each self-navigating platform 330) to avoid collision.

In further embodiments, self-navigating platforms 330 may be configured to transport pallets 314 or shelving units together with items 313 loaded thereon. For example, self-navigating platforms 330 may be sized to fit under pallets 314 or shelving units as they are unloaded from lift mechanism 321 using extending arms 322. Self-navigating platforms 330 may thus be able to transport pallets 314 or shelving units to designated locations within a floor of fulfillment center 300 via a process described below with respect to FIG. 4.

FIG. 4 is a flow chart of an exemplary process 400 for managing the flow of items 313. Process 400 may be performed by WMS 119 or another networked system such as a warehouse control system (WCS) (not shown), which is dedicated to managing automated item handling equipment in fulfillment center 300, such as conveyor network 310, lift system 320, and self-navigating platforms 330.

In some embodiments, WCS may be implemented as a computer system that receives data from network databases in connected systems like WMS 119 and communicate with different automated item handling equipment to execute process 400 and others such as inventory movement, order fulfillment, and/or replenishment. In some embodiments, WCS may be configured to send commands wirelessly to various automated item handling equipment to control their movement or behavior in a way that facilitates flow of items 313 in concert with WMS 119. For example, WCS may control conveyor network 310, lift system 320, and self-navigating platforms 330 to move items 313 from buffer zone 205 to picking zone 209 and update information in WMS 119 to reflect where each item 313 is stored, how many there are, by when they must be sold, etc. On the other hand, WCS may also control conveyor network 310, lift system 320, and self-navigating platforms 330 to retrieve items 313 in response to signals from WMS 119 that certain items 313 are required to fulfill a customer order.

At step 401, WCS may receive a first user input corresponding to a group identification code. The first user input may be inputted, for example, via mobile devices (e.g., devices 107A-107C or 119A-119C) utilized by workers 315 at work stations 312. Group identification code may be a pre-generated sequence of characters assigned for identifying and referencing purposes. Its use is described below as subsequent steps are explained. In some embodiments, the mobile devices may be configured to determine that a different type of identification code (e.g., a tote identification code) has been scanned instead of a group identification code and notify workers 315 to try again. Such determinations may be based on the sequence of characters or by looking up the inputted identification against a list of known group identification codes. Notifications from the mobile devices may be any combination of auditory, tactile, or visual feedback.

At step 402, WCS may receive a second user input corresponding to one or more tote identification codes to be loaded on pallet 314 or shelving unit. Similar to the first user input, the tote identification codes may be inputted via the mobile devices utilized by workers 315 at work stations 312. The tote identification codes may comprise a plurality of pre-generated sequences of characters, each assigned to a tote or a storage unit containing one or more items 313. A tote may contain one unit of an item, a plurality of same items, or any combination of different items. Similarly, items 313 associated with the tote identification codes received in the second user input may comprise multiple units of the same item or a combination of different items. In some embodiments, having a tote identification code may allow WCS to request or retrieve item identification codes (e.g., SKU codes) of the one or more items 313 included in the corresponding tote or storage unit.

In some embodiments, step 402 may further comprise associating the group identification code received in the first user input and the tote identification codes received in the second user input, so that the tote identification codes are recorded in WMS 119 to be grouped together. In such embodiments, the mobile devices may be configured to determine whether a different type of identification code (e.g., a group identification code) has been scanned instead of a tote identification code and notify workers 315 to try again. Such determinations and notifications may be similar to those described above with respect to step 401. Additionally or alternatively, the mobile devices may also be configured to determine whether the tote identification code included in the second user input (1) is already associated with another group identification code; (2) is one of the tote identification codes included in the second user input; or (3) does not correspond to one of the totes ready to be associated with a group identification code. The mobile devices may be configured to notify workers 315 in a manner similar to those described above.

Still further, the mobile devices may also be configured to determine whether a tote identification code is invalid due to any physical damage to the code itself such as a barcode printed on the tote being effaced or covered. In such cases, workers 315 may be prompted to resolve the issue by reprinting the barcode or rearranging the totes or items 313. A tote identification code may also be determined to be invalid due to there not being a record of intake at inbound zone 203 or there not being a request to store the corresponding tote. These issues may be resolved manually by a worker 315 reviewing a log of events associated with the tote identification code or by WCS or WMS 119 being configured to retrace its records to identify potential missteps.

At step 403, WCS may assign the group identification code to a storage location based on one or more items 313 associated with the one or more tote identification codes. The storage location may include a specific location in one of the floors in the fulfillment center 300 designated for storing items 313, such as picking zone 209. In some embodiments, the actual location of the storage location may be unknown to workers 315, being referenced only by a location identification code. WCS or WMS 119 may assign a location identification code to each particular storage location without surfacing the information to workers 315 or other employees in the fulfillment center 300 unless specifically sought after.

In some embodiments, assigning the group identification code to a storage location may comprise retrieving, from network databases storing information associated with the items 313, item information and storage information; and categorizing the one or more items 313 into a common group based on one or more filtering rules 517 (described below). The network databases may include, for example, WCS, WMS 119, FO system 113, SCM 117, or 3^{rd} party fulfillment systems 121A-C.

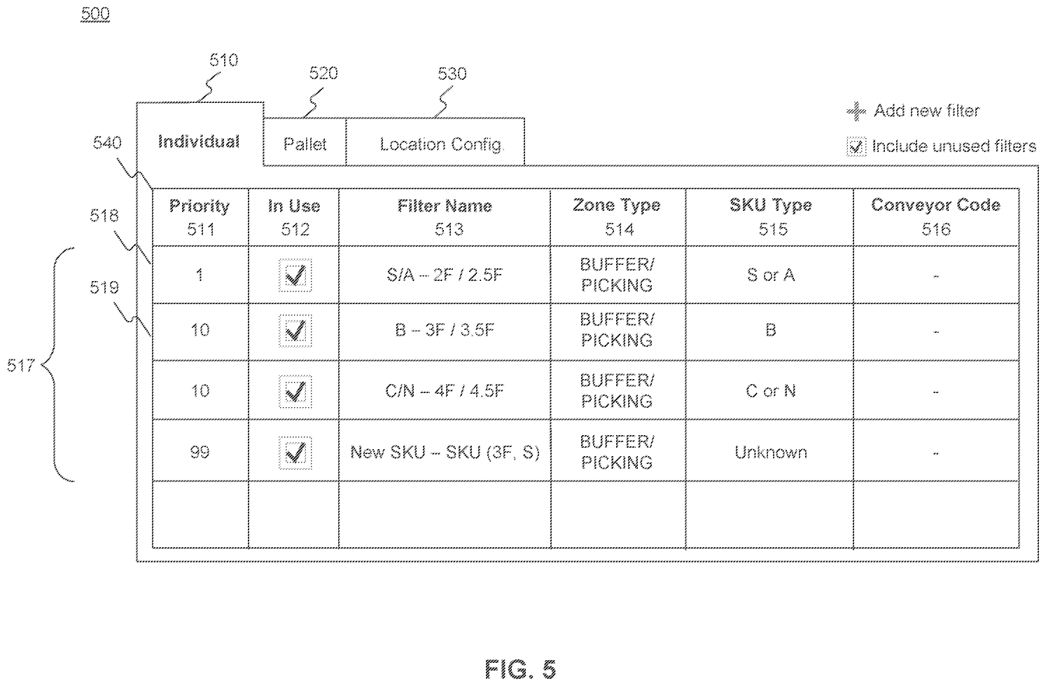

In some embodiments, categorizing items 313 may be performed based on user input received via a graphical user interface configured to allow a user to define or adjust one or more filtering rules 517. The graphical user interface may be configured to allow selective activation of filtering rules 517 based on user input, as is described below in more detail with respect to FIG. 5.

At step 404, WCS may activate conveyor 311 to transport pallet 314 or shelving unit containing items 313. Subsequently, at step 405, WCS may determine transportability of pallet 314 or shelving unit using sensor inputs from one or more sensors described above. For example, WCS may use the weight sensor to determine a weight of pallet 314 or shelving unit with items 313 loaded thereon, ensuring that pallet 314 or shelving unit stays within operating limits of conveyor network 310, lift system 320, and self-navigating platforms 330. Additionally or alternatively, WCS may use the clearance sensor to determine whether pallet 314, shelving unit, or any of items 313 loaded thereon could interfere with or catch on moving or non-moving parts of conveyor network 310, lift system 320, or self-navigating platforms 330 or their surroundings.

In some embodiments, WCS may be configured to prevent or block any movement of a section of conveyor 311 where the particular pallet 314 or shelving unit being analyzed is located. WCS may prevent or block movement using the lock mechanism at least until the transportability is determined or pallet 314 or shelving unit is loaded onto self-navigating platform 330. This may be to prevent situations where the transportability is determined to be insufficient, and pallet 314 or shelving unit is rejected and recalled for adjustment.

When WCS determines that the transportability of pallet 314 or shelving unit is indeed insufficient, WCS may reactivate (e.g., by disengaging the locking mechanism) the section of conveyor 311 and return pallet 314 or shelving unit to work station 312 or another station dedicated to handling rejected pallet 314 or shelving unit. Items 313 in returned pallet 314 or shelving unit may be divided into a plurality of subgroups, such that the heavier or bulkier items 313 are distributed to additional pallets 314 or shelving units. In some embodiments, dividing items 313 into subgroups may comprise moving a subset of items 313 to another tote and associating the corresponding item identification codes with a tote identification code of the new tote. This new tote with the subset of items 313 may then be transported and loaded onto another pallet 314 or shelving unit through process 400 again.

On the other hand, when WCS determines that the transportability of pallet 314 or shelving unit meets a minimum threshold, WCS may reactivate (e.g., by disengaging the locking mechanism on the section of conveyor 311) and continue transporting pallet 314 or shelving unit to lift system 320.

At step 406, WCS may cause extending arms 322 to transfer pallet 314 or shelving unit from conveyor 311 to lift mechanism 321, move lift mechanism 321 to move to a floor corresponding to the location assigned to the group identification code of items 313 loaded on pallet 314 or shelving unit, and transfer pallet 314 or shelving unit from lift mechanism 321 to self-navigating platform of the destination floor. In some embodiments, the originating floor (i.e., the floor where conveyor 311 is located) and the destination floor may be different, with the destination floor being located above or below the originating floor in a multi-story fulfillment center 300. For example, the originating floor may be located on a ground level where inbound zone 203, buffer zone 205, and/or drop zone 207 are located, whereas the destination floor may be located in different levels of picking zone 209.

In some embodiments, once self-navigating platform 330 has transported pallet 314 or shelving unit to the assigned location, self-navigating platform 330 may return to lift system 320 or other staging area to be ready to transport other pallet 314 or shelving unit as received from lift system 320. In further embodiments, WCS may be configured to send a confirmation signal to WMS 119 once pallet 314 or shelving unit has been safely transported to the intended location. The confirmation signal may comprise other information such as the quantity of items 313 stored on the pallet 314 or shelving unit and/or earliest expiration date of the items 313.

Furthermore, stored pallets 314 or shelving units may be retrievable from the location using at least one of the group identification codes, any one of the tote identification codes associated therewith, or any one of the item identification codes of the one or more items associated with the tote identification codes. For example, WCS may receive a signal from WMS 119 to fulfill a customer order comprising items 313 stored in one of the stored pallets 314 or shelving units. WCS may then direct self-navigating platforms 330 to retrieve particular pallets 314 or shelving units containing items 313 that the customer ordered and transport the particular pallets 314 or shelving units to a picking station (not shown), where a worker may pick appropriate quantities of items 313 from pallets 314 or shelving units.

In some embodiments, process 400 may further comprise reporting storage failures. For example, workers 315 may be able to report any issues that arise during process 400, such as damaged items in any of the totes, insufficient number of items, or the like. WCS may activate conveyor network 310, lift system 320, and/or self-navigating platforms 330 to transport the problematic tote, pallet 314, or shelving unit to a collect buffer zone, where the issues may be resolved. For example, a number of items 313 below the expected quantity or damaged items 313 may be addressed by retrieving additional quantities of the corresponding item and either adding the new quantity of items to the tote, pallet 314, or shelving unit.

In some embodiments, totes, pallets 314, or shelving units with items 313 that are damaged by a disproportionate amount may be marked for return to a corresponding vendor. In the simplest embodiment, for example, workers 315 may open a box of items 313 and find most of the items damaged on arrival. In other embodiments, workers 315 may update records in network databases (e.g., WMS 119) to mark item identification codes associated with damaged items as being damaged. WMS 119 may then be configured to determine that a percentage of items 313 received from a particular vendor is defective or damaged and generate a notification to administrators that the corresponding batch of items 313 should be returned. In some embodiments, WCS may control conveyor system 310 to transport items 313 marked as damaged, defective, or to be returned, or totes, pallets 314, or shelving units containing such items 313 to a designated area in fulfillment center 300.

FIG. 5 is an exemplary graphical user interface 500 for managing different filtering rules 517 for facilitating the flow of items 313. In some embodiments, graphical user interface 500 may be displayed on computing devices that are connected to WCS and WMS 119, such as internal front end system 105. In further embodiments, graphical user interface 500 may be a software program running on computing devices that can access and modify operating parameters of WCS. Still further, graphical user interface 500 may be configured to display data received from different networked systems such as those described above with respect to FIG. 2. This information may include, for example, SKU codes for individual items 313, item types (e.g., dairy, regular, refrigerated, fresh, frozen, etc.) barcodes, weight, dimension, expiration date, date of manufacture, or any other parameters or information recorded. WCS may use such information to determine which totes should be grouped together, and/or which location pallet 314 or shelving unit containing the group should be assigned to, as in step 403 above.

In some embodiments, graphical user interface 500 may comprise different tabs—an individual filters tab 510, a pallet filters tab 520, and location configuration tab 530. Individual filters tab 510 may display and allow manipulation of one set of filtering rules 517 applicable for categorizing items 313 to be loaded in combination with different items. Pallet filters tab 520 may display and allow manipulation of another set of filtering rules 517 applicable for categorizing items 313 to be loaded in bulk quantities with no other items. For example, WCS may apply filtering rules displayed in individual filters tab 510 for categorizing (i.e., grouping) different quantities of items A, B, and C so that they may be loaded onto one pallet 314 or shelving unit and stored together; and apply filtering rules displayed in pallet filters tab 520 for categorizing a plurality of item A into a group and loading them onto another pallet 314 or shelving unit alone, without any of items B or C. Location configuration tab 530 may display a number of settings and parameters for different storage locations in fulfillment center 300, such as, for example, whether a particular location is available for storage versus being closed off for maintenance.

In some embodiments, individual filters tab 510 may comprise a table 540 with a priority column 511, a usage column 512, a name column 513, a SKU type column 515, and a conveyor code column 516, with each filtering rule 517 being displayed in a row. Pallet filters tab 520 may also comprise a similar table with similar columns.

Data shown in priority column 511 may indicate the priority with which corresponding filtering rule 517 is applied. For example, a first filtering rule 518 may be applied to any given tote to determine its group before a second filtering rule 519 is applied. Usage column 512 may comprise a series of checkboxes indicating whether the corresponding filtering rule 517 is being applied or not. Data shown in zone type column 514 may indicate the zones to which the totes to be categorized are will be stored. In some embodiments, the zones listed in zone type column 514 may correspond to the zones described above with respect to FIG. 2. For example, totes categorized using filtering rules 517 are to be assigned to a location in buffer zone 205 or picking zone 209. Data shown in SKU type column 515 may indicate the types of SKUs appropriate for the corresponding filtering rule 517. For example, first filtering rule 518 may apply only to tote containing items 313 of SKU types S or A. Data shown (or to be shown) in conveyor code 516 may indicate conveyor identification codes to be used for transporting the totes. The values, names, types, or numbers shown in table 540 are only exemplary and not intended to be limiting. Any other values, names, types, or numbers may be used to cater to different fulfillment centers' needs.

In some embodiments, WCS may apply a set of basic rules for each filtering rule 517. An exemplary set of basic rules is described below, but these rules are not intended to be limiting and may be added, removed, or revised to cater to different fulfillment centers' needs.

First, filtering rule 517 may require only one type of item to be loaded for each pallet 314 or shelving unit. For example, a refrigerated item may not be grouped with a frozen or non-refrigerated item to be loaded on to the same pallet 314 or shelving unit. Second, filtering rule 517 may require all items 313 in one group to have the same expiration or use by date. Third, filtering rule 517 may limit each group to a maximum number of distinct items, with or without regard to a quantity of any one particular item. Fourth, filtering rule 517 may require items 313 in each group to have the same intended customer base (e.g., retail vs. wholesale).

In further embodiments, graphical user interface 500 may comprise a filtering rule configuration interface (not shown) that allows a user to input different parameters to define or revise filtering rule 517. For example, graphical user interface 500 may accept values from the user on parameters including: SKU type, storage temperature, volume, weight, length of any one side, linear sum of all sides, length of the longest side, length of the shortest side, length of a middle-sized side, whether SKU is new or unknown, previously assigned group identification code, priority, and/or maximum number of distinct items.

WCS may compare these parameters to item information retrieved from networked systems (e.g., WMS 119) to determine whether items 313 in a tote matches the parameters of filtering rule 517 and assign a group based on such determination. To this end, each parameter may be paired with a Boolean or mathematical operator specifying whether parameters of a particular item should match the parameter set in filtering rule 517 or not, should be greater, less than, or equal to the parameter set, or the like.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A pallet transport system for product intake, stocking, and retrieval, the system comprising:
a memory storing instructions; and
at least one processor configured to execute the instructions for:
receiving a first user input corresponding to a group identification code;
receiving a second user input corresponding to one or more tote identification codes to be loaded on a pallet;
assigning the one or more tote identification codes to a group corresponding to the group identification code;
assigning the group identification code to a location based on one or more items associated with the one or more tote identification codes;
activating a conveyor to transport the pallet containing the one or more items;
determining, using a first sensor input from the weight sensor, a transportability of the pallet; and
causing a lift mechanism to transfer the pallet from the conveyor to a self-navigating platform.

2. The pallet transport system of claim 1, wherein assigning the group identification code to a location comprises:
retrieving, from a network database storing information associated with the one or more items, item information and storage information;
categorizing the one or more items into a common group based on one or more filtering rules.

3. The pallet transport system of claim 1, wherein the instructions further comprise:
displaying a graphical user interface configured to receive user input for defining or adjusting the one or more filtering rules

4. The pallet transport system of claim 3, wherein the graphical user interface is configured to allow selective activation of the one or more filtering rules based on the user input.

5. The pallet transport system of claim 1,
further comprising a clearance sensor configured to determine dimensions of the pallet, and
wherein the instructions further comprise determining, using a second sensor input from the clearance sensor to further determine transportability of the pallet.

6. The pallet transport system of claim 5, wherein using the clearance sensor to further determine transportability of the pallet comprises:
comparing at least one of a width, a length, a height, a linear sum of the dimensions, a maximum of the dimensions, or a minimum of the dimensions against one or more constraints of the conveyor or the self-navigation platform.

7. The pallet transport system of claim 1, wherein the instructions further comprise:
preventing a movement of the conveyor until the pallet is loaded onto the self-navigating platform,
wherein the conveyor is locked using a mechanical lock configured to block the movement when engaged or using a software lock configured to deny a request to move the conveyor.

8. The pallet transport system of claim 1, wherein the instructions further comprise:
reactivating the conveyor to return the pallet based on determining that the transportability of the pallet does not meet one or more requirements,
wherein the returned pallet is divided into a plurality of subgroups, each being associated with a subset of the one or more tote identification codes.

9. The pallet transport system of claim 1, wherein the pallet is retrievable from the location using at least one of the group identification code, any one of the one or more tote identification codes, or an item identification code of the one or more items.

10. The pallet transport system of claim 1, wherein the lift mechanism is configured to transfer the pallet between two or more different floors, wherein the two or more different floors are arranged vertically.

11. A computer-implemented method for product intake, stocking, and retrieval, the method comprising:
receiving a first user input corresponding to a group identification code;
receiving a second user input corresponding to one or more tote identification codes to be loaded on a pallet;
assigning the one or more tote identification codes to a group corresponding to the group identification code;
assigning the group identification code to a location based on one or more items associated with the one or more tote identification codes;
activating a conveyor to transport the pallet containing the one or more items;
determining, using a first sensor input from a weight sensor, a transportability of the pallet; and
causing a lift mechanism to transfer the pallet from the conveyor to a self-navigating platform.

12. The computer-implemented method of claim 11, wherein assigning the group identification code to a location comprises:
retrieving, from a network database storing information associated with the one or more items, item information and storage information;
categorizing the one or more items into a common group based on one or more filtering rules.

13. The computer-implemented method of claim 11, wherein the instructions further comprise:
displaying a graphical user interface configured to receive user input for defining or adjusting the one or more filtering rules

14. The computer-implemented method of claim 13, further comprising:
receiving, via the graphical user interface, selective activation of the one or more filtering rules based on the user input.

15. The computer-implemented method of claim 11, further comprising:
determining, using a second sensor input from a clearance sensor to further determine transportability of the pallet,
wherein the clearance sensor is configured to determine dimensions of the pallet.

16. The computer-implemented method of claim 15, wherein using the clearance sensor to further determine transportability of the pallet comprises:
comparing at least one of a width, a length, a height, a linear sum of the dimensions, a maximum of the dimensions, or a minimum of the dimensions against one or more constraints of the conveyor or the self-navigation platform.

17. The computer-implemented method of claim 11, further comprising:
preventing a movement of the conveyor until the pallet is loaded onto the self-navigating platform,
wherein the conveyor is locked using a mechanical lock configured to block the movement when engaged or using a software lock configured to deny a request to move the conveyor.

18. The computer-implemented method of claim 11, further comprising:
reactivating the conveyor to return the pallet based on determining that the transportability of the pallet does not meet one or more requirements,
wherein the returned pallet is divided into a plurality of subgroups, each being associated with a subset of the one or more tote identification codes.

19. The computer-implemented method of claim 11, wherein the pallet is retrievable from the location using at least one of the group identification code, any one of the one or more tote identification codes, or an item identification code of the one or more items.

20. A pallet transport system for product intake, stocking, and retrieval, the system comprising:
a conveyor configured to transport a pallet;
a lift mechanism configured to transfer the pallet from the conveyor to a self-navigating platform;
a memory storing instructions; and
at least one processor configured to execute the instructions for:
receiving a first user input corresponding to a group identification code;
receiving a second user input corresponding to one or more tote identification codes to be loaded on the pallet;
assigning the group identification code to a location based on one or more items associated with the one or more tote identification codes;
activating the conveyor located on a first floor to transport the pallet containing the one or more items; and
using the lift mechanism to transfer the pallet from the conveyor to a self-navigating platform located on a second floor located above or below the first floor, wherein the second floor is determined based on the assigned location.
